(19) United States
(12) Patent Application Publication
(10) Pub. No.: US 2025/0071768 A1
(43) Pub. Date: Feb. 27, 2025

(54) SYSTEMS AND METHODS FOR BEAM INDICATION IN A UNIFIED TRANSMISSION CONTROL INDICATOR (TCI) FRAMEWORK

(71) Applicant: Apple Inc., Cupertino, CA (US)

(72) Inventors: Yushu ZHANG, Beijing (CN); Chunxuan YE, San Diego, CA (US); Dawei ZHANG, Saratoga, CA (US); Haitong SUN, Cupertino, CA (US); Hong HE, San Jose, CA (US); Huaning NIU, San Jose, CA (US); Wei ZENG, Saratoga, CA (US); Weidong YANG, San Diego, CA (US)

(21) Appl. No.: 18/724,543

(22) PCT Filed: Jan. 4, 2022
(86) PCT No.: PCT/CN2022/070072

§ 371 Date: Jun. 26, 2024

(51) Int. Cl. H04W 72/23; H04B 7/06; H04W 72/0446

(52) U.S. Cl. CPC H04W 72/23; H04B 7/06962; H04W 72/0446

(57) ABSTRACT

A user equipment (UE) includes a set of one or more transceivers and a processor. The processor is configured to determine, at least partly from a transmission control indicator (TCI) state for multiple channels, that common physical downlink shared channels (PDSCHs) do not share a beam with dedicated PDSCHs. The processor is also configured to determine a physical downlink control channel (PDCCH)/PDSCH scheduling offset is below a threshold; select, at least partly based on the determination that common PDSCHs do not share a beam with dedicated PDSCHs and the determination the PDCCH/PDSCH scheduling offset is below the threshold, a beam for which to buffer PDSCH; and buffer PDSCH received on the beam.

### CROSS-REFERENCE TO RELATED APPLICATION

This application is a 35 U.S.C. § 371 application of PCT/CN2022/070072, filed on Jan. 4, 2022, and entitled “Systems and Methods for Beam Indication in a Unified Transmission Control Indicator (TCI) Framework,” which is incorporated herein by reference as if fully disclosed herein.

### TECHNICAL FIELD

This application relates generally to wireless communication systems, including methods and implementations of beam indication in a unified transmission control indicator (TCI) framework.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system.

FIGS. 2A-2E show various examples of carrier aggregation modes.

FIG. 3 shows an example set of subcarriers having different carrier spacings and subframe structures.

FIG. 4 shows an example timeline for the transmission of PDCCHs and PDSCHs on one or more carriers (e.g., subcarriers or CCs).

FIG. 5 shows an example method of a UE, which method may be used to determine a beam for which PDSCH should be buffered.

FIGS. 6 and 7 show example selections of a beam for which to buffer PDSCH.

FIG. 8 shows an example MAC CE.

FIG. 9 shows an example method of a UE, which method may be used to determine a beam for transmitting SRS and/or a set of power control parameters for transmitting SRS.

FIG. 10 shows example structures of a first MAC CE and a second MAC CE that may be used in conjunction with the method shown in FIG. 9.

FIG. 11 shows an example structure of a MAC CE that may be used in conjunction with the method shown in FIG. 9.

FIG. 12 shows an example method of a base station, which method may be used to indicate, to a UE, a beam for transmitting SRS and/or a set of power control parameters for transmitting SRS.

FIG. 13 illustrates an example architecture of a wireless communication system, according to embodiments disclosed herein.

FIG. 14 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In 3GPP Release 17 (Rel-17), a unified TCI framework is being introduced. In accord with such a unified TCI framework, a base station (e.g., a gNB) can indicate, to a UE, a TCI state that provides an antenna port quasi-co-location (QCL) indication (e.g., a beam indication) for downlink (DL) transmissions (e.g., physical downlink control channel (PDCCH)/physical downlink shared channel (PDSCH) transmissions) and/or uplink (UL) transmissions (e.g., physical uplink shared channel (PUSCH)/physical uplink control channel (PUCCH) transmissions).

A base station may configure one or more TCI states. Each TCI state may be used to provide a beam indication. In some cases, a base station may indicate a common TCI state for multiple channels including one or more UL channels and/or one or more DL channels. Currently, there are two modes for such a common TCI state (Mode 1 and Mode 2). Mode 1 is a joint TCI mode (or joint DL/UL mode), in which a single “joint” TCI state is used to provide a common beam indication for multiple channels including both one or more DL channels and one or more UL channels. Mode 2 is a separate DL/UL mode, in which a DL TCI state may be used to provide a common beam indication for multiple DL channels, and/or an UL TCI state may be used to provide a beam indication for multiple UL channels.

When a base station provides a beam indication in accord with Mode 1 or Mode 2, the “multiple channels” to which the TCI state applies always include (as appropriate, depending on whether the beam indication is provided for a combination of DL/UL channels or separate DL/UL channels) dedicated PDCCH/PDSCH (i.e., PDCCH/PDSCH associated with a Control Resource Set (CORESET) for dedicated transmission, such as a CORESET associated with a UE-specific search space (USS)), and PUCCH/PUSCH.

When a base station provides a beam indication in accord with Mode 1 or Mode 2, the “multiple channels” to which the TCI state applies may optionally include (as appropriate, depending on whether the beam indication is provided for a combination of DL/UL channels or separate DL/UL channels) common PDCCH/PDSCH (i.e., PDCCH/PDSCH associated with a CORESET for non-dedicated transmission, such as a CORESET associated with a common search space (CSS)); aperiodic CSI-RS for channel state information (CSI) acquisition or beam management; and/or sounding reference signal (SRS) for codebook/non-codebook/antenna switching/beam management. When optional channels are included in the multiple channels indicated by a TCI state, the inclusion of the optional channels may be configured, by a base station, via radio resource control (RRC) signaling.

In the case of uplink power control parameter indication (by a base station), each joint or UL TCI state can be associated with a set of power control parameters. The power control parameters may include P0, alpha, and a closed-loop process index, and a pathloss reference signal. The P0, alpha, and closed-loop process index may be provided for each applicable channel. When the power control parameters are not provided, default power control parameters may be applied. However, a pathloss reference signal should always be provided. When a TCI state is indicated, the power control parameters associated with the TCI state may be used for uplink power control.

Because a UE cannot predict which PDCCH will schedule PDSCH, a UE that is unable to decode PDCCH before PDSCH is received may buffer PDSCH. In this manner, PDSCH may be received and decoded even when it cannot be decoded as it is received (e.g., because PDCCH is not yet decoded). However, when common PDCCH/PDSCH does not share a beam with dedicated PDCCH/PDSCH, the beam on which PDSCH will be received, if at all, is unclear. Because a UE may be unable to buffer PDSCH received on multiple beams, an unresolved issue within the TCI framework is how a UE determines a beam for which to buffer PDSCH when 1) common PDCCH/PDSCH does not share a beam with dedicated PDCCH/PDSCH (e.g., because a TCI state for multiple channels does not apply to common PDCCH/PDSCH), and 2) a PDCCH/PDSCH scheduling offset is below a threshold (e.g., below a threshold amount of time that does not allow PDCCH to be decoded by the UE before PDSCH is received). A similar issue exists for aperiodic CSI-RS, when aperiodic CSI-RS does not share the beam indicated by a TCI state.

When SRS does not share an indicated TCI state, another issue within the TCI framework is how to provide the TCI state and power control parameter indications for SRS. To maintain a consistent transmission power across SRS resources, the power control parameters should be common for SRS resources in a resource set.

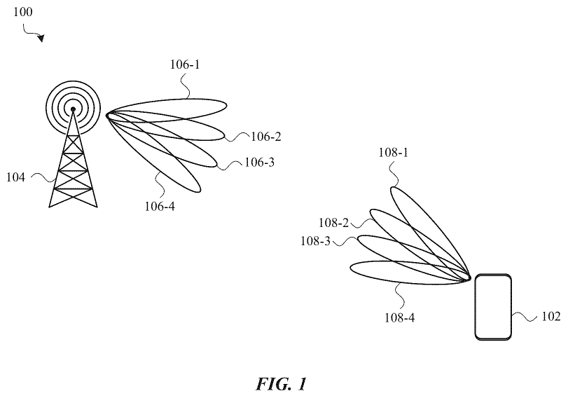

FIG. 1 shows an example wireless communication system 100, according to embodiments disclosed herein. The wireless communication system 100 may operate in accord with the LTE system standards, 5G or NR system standards, or other standards provided by 3GPP technical specifications.

As shown in FIG. 1, the wireless communication system 100 may include a UE 102 and a base station 104 (e.g., an eNB or gNB). In some embodiments, the UE 102 may be one of multiple UEs that simultaneously or contemporaneously communicate with the base station 104. In some embodiments, the base station 104 may, alone or in combination with one or more other base stations, form part or all of a cellular RAN.

In some cases, the base station 104 may transmit one or more DL channels to the UE 102. The DL channels may be transmitted on one or multiple DL beams 106 (e.g., DL beams 106-1, 106-2, 106-3, and/or 106-4). Similarly, the UE 102 may transmit one or more UL channels to the base station 104. The UL channels may be transmitted on one or multiple UL beams 108 (e.g., UL beam 108-1, 108-2, 108-3, and/or 108-4).

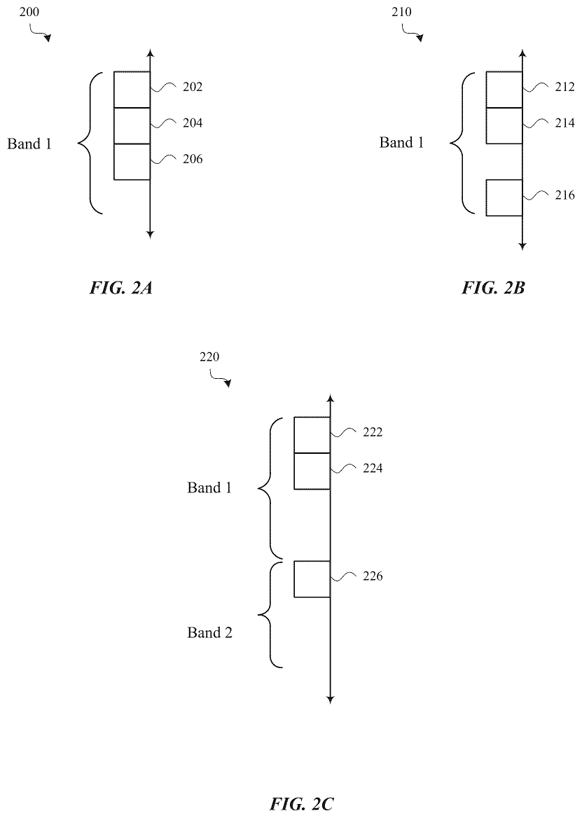

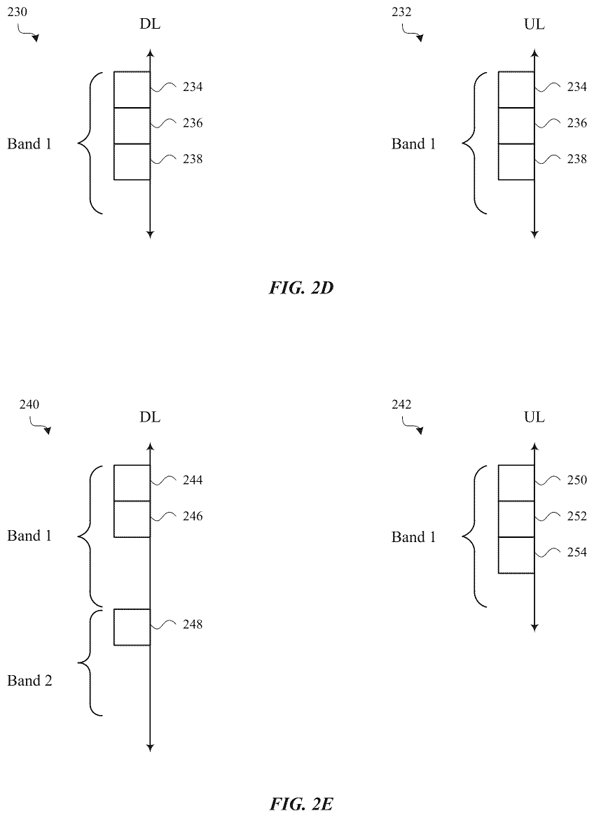

In some cases, the UE 102 and the base station 104 may communicate on a single carrier. In other cases, the UE 102 and the base station 104 may communicate on multiple component carriers (CCs) in a carrier aggregation mode. FIGS. 2A-2E show various examples of carrier aggregation modes.

FIG. 2A shows an example carrier aggregation mode 200 (for DL or UL communication) in which a communication between a UE and a base station occurs on a set of intra-band, contiguous CCs 202, 204, 206. FIG. 2B shows an example carrier aggregation mode 210 (for DL or UL communication) in which a communication between a UE and a base station occurs on a set of intra-band, non-contiguous CCs 212, 214, 216. FIG. 2C shows an example carrier aggregation mode 220 (for DL or UL communication) in which a communication between a UE and a base station occurs on a set of inter-band, non-contiguous CCs 222, 224, 226. FIG. 2D shows an example DL carrier aggregation mode 230 and example UL carrier aggregation mode 232 in which both the DL carrier aggregation mode 230 and the UL carrier aggregation mode 232 use the same set of CCs 234, 236, 238. FIG. 2E shows an example DL carrier aggregation mode 240 and example UL carrier aggregation mode 242 in which the DL carrier aggregation mode 240 uses a first set of CCs 244, 246, 248 and the UL carrier aggregation mode 242 uses a second set of CCs 250, 252, 254 that differs from the first set of CCs 244, 246, 248.

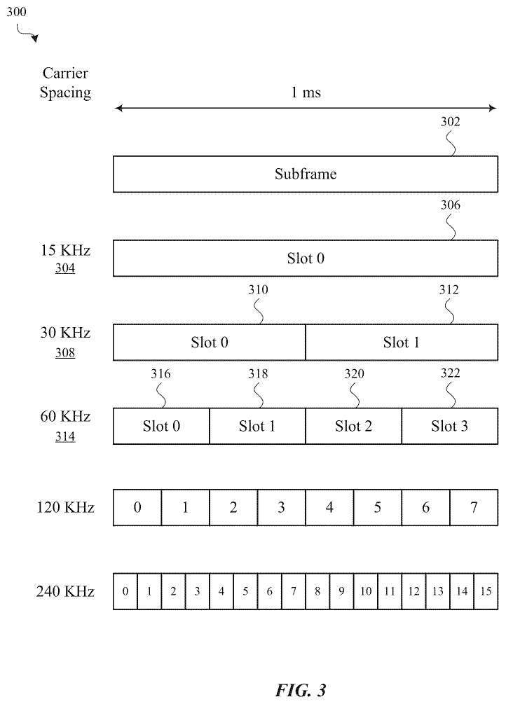

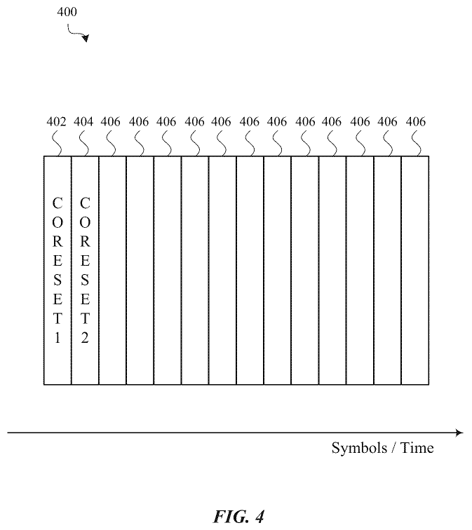

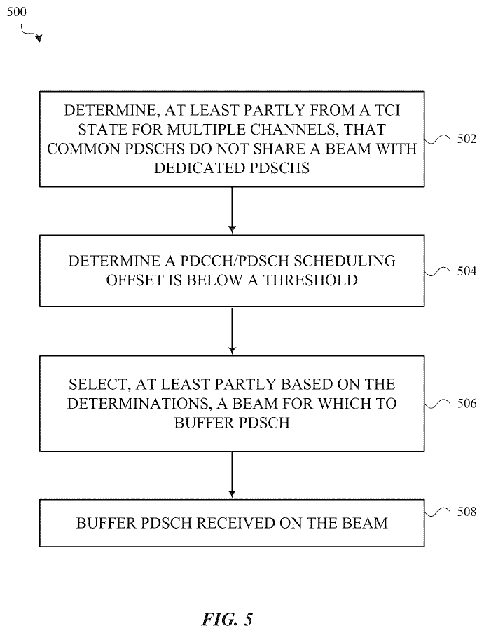

FIG. 3 shows an example set of subcarriers 300 having different carrier spacings and subframe structures. The subcarriers 300 are examples of the CCs described with reference to FIGS. 2A-2E. Each of the subcarriers 300 is subdivided into a number of same size subframes 302, both within a subcarrier 300 and between the subcarriers 300. However, the number and size of slots that are allocated within the subframe 302 may vary between different subcarriers. For example, a first subcarrier 304 may have a single slot 306 (Slot 0) per subframe 302. A second subcarrier 308 may have a pair of slots 310, 312 (Slots 0 and 1) per subframe 302. A third subcarrier 314 may have four slots 316, 318, 320, 322 (Slots 0, 1, 2, and 3) per subframe 302; and so on.

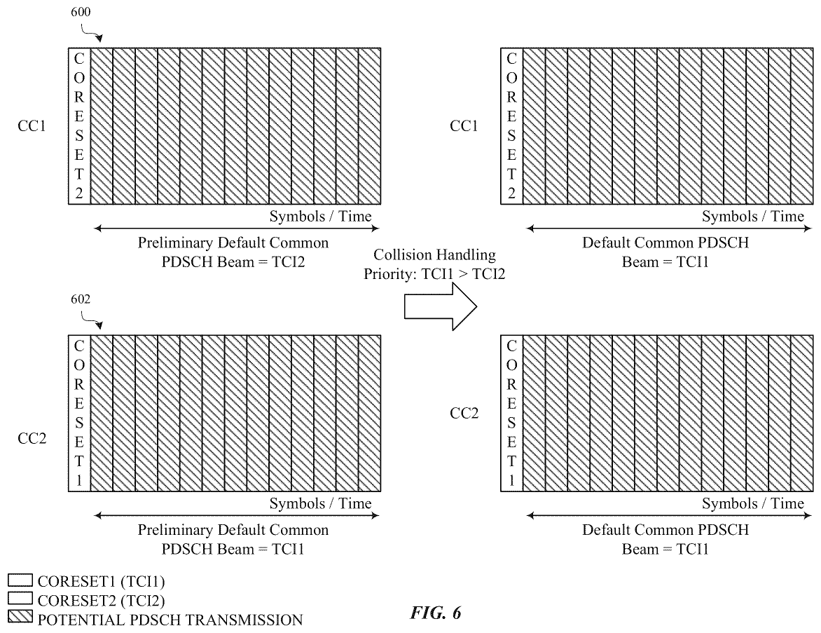

FIG. 4 shows an example timeline 400 for the transmission of PDCCHs and PDSCHs on one or more carriers (e.g., subcarriers or CCs). By way of example, the PDCCHs include a first PDCCH 402 that includes a common CORESET (CORESET1) and a second PDCCH 404 that includes a dedicated CORESET (CORESET2). Following the transmissions of the first and second PDCCHs 402, 404 are a number of time intervals 406 in which a common PDSCH or a dedicated PDSCH may be transmitted. When a joint TCI state or DL TCI state does not apply to common PDCCH/PDSCH, a common PDSCH may not be transmitted on the same beam as a dedicated PDSCH and, thus, a UE may not be able to identify the beam on which PDSCH is to be received (if any) prior to decoding the common and dedicated PDSCHs 402, 404. When the PDCCH/PDSCH scheduling offset is below a threshold, the UE may buffer PDSCH. However, the UE may only be able to buffer PDSCH received on a single beam and, when common and dedicated PDSCHs are received on different beams, the beam for which to buffer PDSCH is unclear.

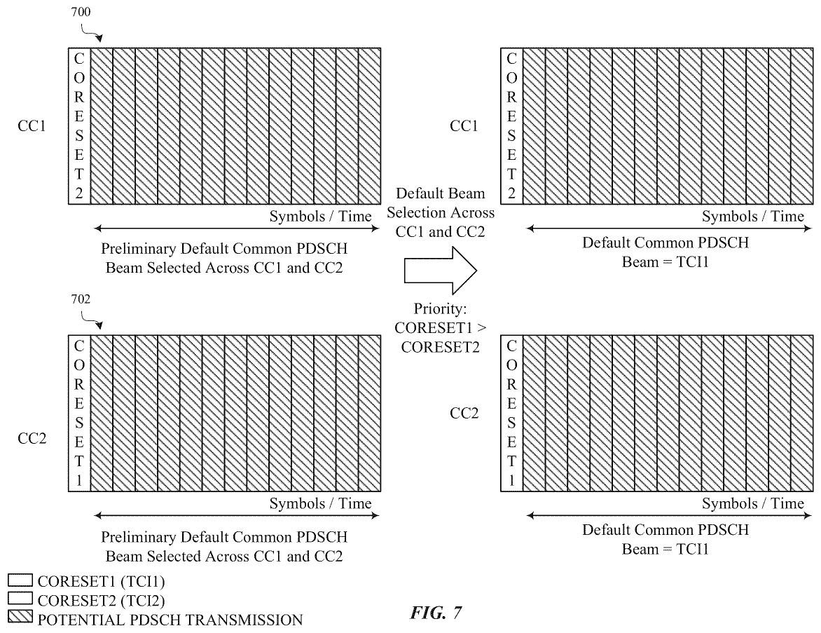

Regarding the issue of not knowing the beam for which to buffer PDSCH, FIG. 5 shows an example method 500 of a UE, which method 500 may be used to determine a beam for which PDSCH should be buffered.

At block 502, the method 500 may include determining, at least partly from a TCI state for multiple channels, that common PDSCHs do not share a beam with dedicated PDSCHs.

At block 504, the method 500 may include determining a PDCCH/PDSCH scheduling offset is below a threshold (i.e., determine that a time offset between receipt of a PDCCH and receipt of a corresponding PDSCH is below a threshold amount of time, such as less than an amount of time that allows the PDCCH to be decoded before the corresponding PDSCH is received).

At 506, the method 500 may include selecting, at least partly based on the determinations at 502 and 504, a beam for which to buffer PDSCH. In some cases, the selected beam may be a default common PDSCH beam or a default dedicated PDSCH beam.

At 508, the method 500 may include buffering PDSCH received on the beam.

In some embodiments of the method 500, the beam selected at 506 may be a default common PDSCH beam. In at least some of these embodiments, the method 500 may include selecting the default common PDSCH beam based at least partly on QCL information and a TCI state for a monitored CORESET in a latest slot (i.e., a slot that is latest in time). When the UE determines there are multiple monitored CORESETs, the monitored CORESET in the latest slot may in some cases be selected, from the multiple monitored CORESETs, as a CORESET with a lowest identifier (ID). In some cases, the multiple monitored CORESETs may be common CORESETs in an active bandwidth part (BWP).

In some embodiments of the method 500, the beam selected at 506 may be a default dedicated PDSCH beam. In at least some of these embodiments, the method 500 may include selecting the default dedicated PDSCH beam based, at least in part, on the TCI state for multiple channels.

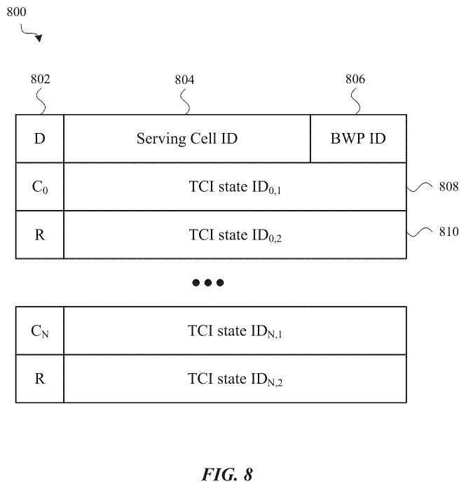

In some embodiments of the method 500, the UE may determine it is configured in a carrier aggregation mode. Since, in a carrier aggregation mode, an antenna is shared at least within a band or a band group, the same default common PDSCH beam should be buffered for each of the configured CCs within the band or band group. In at least some of these embodiments, the method 500 may include identifying a preliminary set of default common PDSCH beams for which to buffer PDSCH, and identifying the beam for which to buffer PDSCH from within the preliminary set of default common PDSCH beams. The preliminary set of default common PDSCH beams may include a preliminary default beam per CC in a band or a band group of the carrier aggregation mode. An example of this is shown in FIG. 6, in which a set of resources for each of a first CC (CC1) and a second CC (CC2) are shown. The set of resources 600 for CC1 include, for example, a first symbol in which a CORESET1 is received and a set of symbols in which PDSCH may be received. A preliminary default common PDSCH beam, for buffering PDSCH, may be selected for CC1 based at least in part on a TCI state 1 (TCI1). The set of resources 602 for CC2 include, for example, a first symbol in which a CORESET2 is received and a set of symbols in which PDSCH may be received. A preliminary default common PDSCH beam, for buffering PDSCH, may be selected for CC2 based at least in part on a TCI state 2 (TC12). Because the preliminary default common PDSCH beams differ, a single beam may be selected and used to buffer PDSCH for both CC1 and CC2. By way of example, the selected beam is shown to be the beam indicated by TCI1. A beam may be selected based on a configured (or preconfigured) priority. The priority may be based on one or more of a CC ID, a TCI state ID, and so on. In FIG. 6, TCI1 is deemed to have a greater priority than TCI2.

In at least some other embodiments in which the UE is configured in a carrier aggregation mode, the method 500 may include identifying the “latest slot” as a slot corresponding to a CC having a minimum (or maximum) slot duration (or minimum or maximum subcarrier spacing) among a set of CCs in a band or a band group of the carrier aggregation mode. For example, in FIG. 3, a CC corresponding to the third subcarrier would have a minimum slot duration, and a CC corresponding to the first subcarrier would have a maximum slot duration. A further example is shown in FIG. 7, in which a set of resources for each of a first CC (CC1) and a second CC (CC2) are shown. The set of resources 700 for CC1 include, for example, a first symbol in which a CORESET1 is received and a set of symbols in which PDSCH may be received. The set of resources 702 for CC2 include, for example, a first symbol in which a CORESET2 is received and a set of symbols in which PDSCH may be received. If CC2 has a smaller slot duration than CC1, CC2 may be the CC with the minimum slot duration and, as a result, may be considered the latest slot for purposes of selecting a beam for buffering PDSCH. If the beam associated with CC2 is the beam associated with TCI1, then PDSCH may be buffered for the beam associated with TCI1.

The UE may be configured to select a beam for buffering PDSCH, at 506, in various ways. For example, in accord with a first option, the UE may select a default common PDSCH beam. In this case, a base station may always schedule dedicated PDSCH with a PDCCH/PDSCH scheduling offset that is greater than a threshold (e.g., greater than the threshold referenced at 502).

In accord with a second option, the UE may select a default dedicated PDSCH beam at 506. In this case, a base station may always schedule common PDSCH with a PDCCH/PDSCH scheduling offset that is greater than a threshold (e.g., greater than the threshold referenced at 502).

In accord with a third option, the method 500 may include receiving, from a base station, an indication regarding whether to select a default common PDSCH beam or a default dedicated PDSCH beam as the beam for which to buffer PDSCH. In some embodiments, the indication may be provided/received in RRC signaling. For example, a parameter may be added to RRC signaling to indicate whether a UE should prioritize a default common PDSCH beam or a default dedicated PDSCH beam for selection at 506. In some embodiments, the indication may be received in a medium access control (MAC) control element (CE). An example indicator in a MAC CE 800 is shown in FIG. 8, in which an indicator “D” 802 is introduced to indicate whether a UE should prioritize a default common PDSCH beam or a default dedicated PDSCH beam for selection at 506. Other example fields included in the MAC CE 800 may include a serving cell ID 804, a BWP ID 806, and one or more TCI states 808, 810, and so on.

In accord with a fourth option, the method 500 may include reporting a UE capability to a base station and, at 506, selecting the beam for which to buffer PDSCH (e.g., a default common PDSCH beam or a default dedicated PDSCH beam) at least partly based on the UE capability. In some cases, the UE capability can be the UE's support (or lack of support) for more than one active TCI state. In some cases, the report of the UE capability may serve as an indication of the beam selected by the UE. In other cases, the report of the UE capability may serve as a basis for the base station to indicate a beam selection (or suggestion) to the UE.

In accord with a fifth option, the beam for which to buffer PDSCH may alternate between a default common PDSCH beam and a default dedicated PDSCH beam in accord with a time domain multiplexing (TDM) framework. In some cases, the beam to be used for a subsequent time period can be determined by the CORESETs in a latest slot. If there are multiple CORESETs configured in the latest slot, a common CORESET may be prioritized. In other cases, a base station may configure a monitoring window for selecting a default common PDSCH beam. Within the monitoring window, a default common PDSCH beam may be selected; and outside the monitoring window, a default dedicated PDSCH beam may be selected (or vice versa). The monitoring window may be configured, for example, by means of RRC signaling or a MAC CE.

In accord with a sixth option, the UE may select (at 506) both a default common PDSCH beam and a default dedicated PDSCH beam for which to buffer PDSCH. This requires the UE to receive multiple beams simultaneously. If the UE has such a capability, the UE may report the UE's capability to a base station.

When aperiodic CSI-RS does not share a beam indicated by a TCI state, a default aperiodic CSI-RS beam may be selected similarly to how a beam is selected for buffering PDSCH (e.g., in accord with one of the above options). The default aperiodic CSI-RS beam should be the same beam selected at 506.

To avoid potential misunderstanding between a base station and UE with regard to the UE's interpretation of a TCI state in downlink control information (DCI), where a TCI state in a dedicated CORESET is the indicated TCI state for multiple channels and a TCI state in a common CORESET may indicate the beam for scheduled PDSCH only (or alternatively, indicate a TCI state for multiple channels), one or both of two safeguards may be implemented. The first safeguard, if implemented, may prohibit a TCI state from being included in DCI for common CORESETs. The second safeguard, if implemented, may only allow a base station to transmit DCI format 1_0 in common CORESETs.

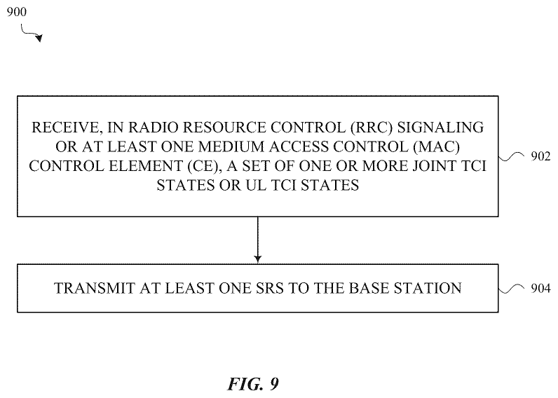

Regarding the issue of how to provide the TCI state and power control parameter indication for SRS when SRS does not share an indicated TCI state (i.e., does not share a TCI state indicated in DCI), FIG. 9 shows an example method 900 of a UE, which method 900 may be used to determine a beam for transmitting SRS and/or a set of power control parameters for transmitting SRS.

At block 902, the method 900 may include receiving, in RRC signaling or at least one medium access control (MAC) control element (CE), a set of one or more joint TCI states or UL TCI states. The set of one or more joint TCI states or UL TCI states may indicate a set of one or more beams on which a set of one or more sounding reference signals (SRSs) are to be transmitted from the UE to a base station.

At block 904, the method 900 may include transmitting at least one SRS to the base station. The at least one SRS may be transmitted on an indicated beam in the set of one or more joint TCI states or UL TCI states, and may be transmitted in accord with a set of one or more power control parameters.

In some embodiments of the method 900, the set of one or more joint TCI states or UL TCI states may be received in RRC signaling, per SRS resource in an SRS resource set. In at least some of these embodiments, a set of one or more power control parameters for transmitting the set of one or more SRSs may also be received in RRC signaling. The set of one or more power control parameters may be received for the SRS resource set. In this manner common power control parameters may be applied to all of the SRS resources in the SRS resource set (or to a single SRS resource when there is only one SRS resource in the SRS resource set). In these embodiments, the UE may ignore any power control parameters associated with the set of one or more joint TCI states or UL TCI states.

In some embodiments of the method 900, the set of one or more joint TCI states or UL TCI states may be received in RRC signaling, per SRS resource in an SRS resource set. In at least some of these embodiments, the method 900 may include applying a set of one or more power control parameters for one SRS resource in the SRS resource set to all of the SRS resources in the SRS resource set. In these embodiments, the UE need not receive the set of one or more power control parameters from the base station. However, the UE may be configured to select a set of one or more power control parameters associated with a particular SRS resource, for application to all of the SRS resources in the SRS resource set. The particular SRS resource may be, for example, an SRS resource with a lowest ID within the SRS resource set, or the first SRS resource in an SRS resource list within the SRS resource set. Alternatively, an SRS resource index can be indicated in RRC signaling received by the UE, and the UE may select a set of one or more power control parameters associated with an SRS resource having the indicated SRS resource index, for application to all of the SRS resources in the SRS resource set.

In some embodiments of the method 900, the UE may apply a combination of the methods described in the preceding two paragraphs. For example, the set of one or more joint TCI states or UL TCI states may be received in RRC signaling, per SRS resource in an SRS resource set. When a set of one or more power control parameters for transmitting the set of one or more SRSs is also received in RRC signaling, the UE may apply the set of one or more power control parameters to all of the SRS resources in the SRS resource set (or to a single SRS resource when there is only one SRS resource in the SRS resource set). However, when a set of one or more power control parameters is not received in RRC signaling, the UE may apply a set of one or more power control parameters for one SRS resource in the SRS resource set to all of the SRS resources in the SRS resource set.

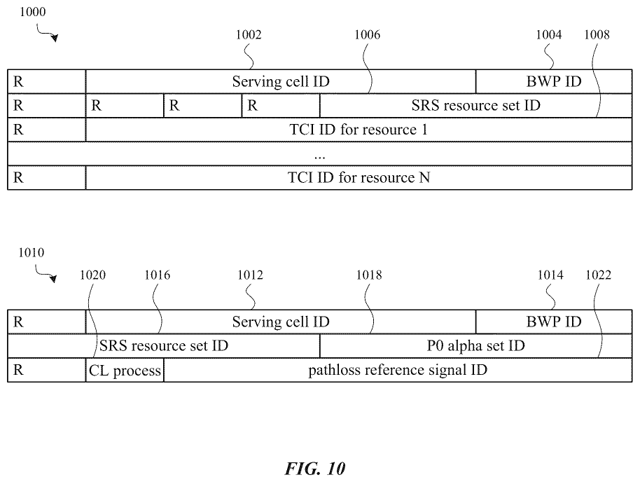

In some embodiments of the method 900, the set of one or more joint TCI states or UL TCI states may be received in a first MAC CE. The set of one or more joint TCI states or UL TCI states may be received per SRS resource in an SRS resource set, per SRS resource set, per group of SRSs across multiple CCs, or per group of SRS resource sets across multiple CCs. In at least some of these embodiments, a set of one or more power control parameters for transmitting the set of one or more SRSs may be received in a second MAC CE. The set of one or more power control parameters may be received per SRS resource set or per group of SRS resource sets across multiple CCs. In this manner common power control parameters may be applied to all of the SRS resources in an SRS resource set or all of the SRS resources in a group of SRS resource sets across multiple CCs (or to a single SRS resource when there is only one SRS resource in an SRS resource set). FIG. 10 shows example structures of the first MAC CE 1000 and the second MAC CE 1010. The first MAC CE 1000 may include one or more of a serving cell ID 1002, a BWP ID 1004, an SRS resource ID, an SRS resource set ID 1006, and a TCI ID for an SRS resource 1008. By way of example, the first MAC CE 1000 includes a TCI ID for each of SRS resources 1 through N. The second MAC CE 1010 may include one or more of a serving cell ID 1012, a BWP ID 1014, an SRS resource set ID 1016, a P0_alpha_set ID 1018, a closed-loop (CL) process index 1020, and a pathloss reference signal index 1022. The P0_alpha_set ID 1018, CL process index 1020, and pathloss reference signal index 1022 are examples of power control parameters. The fields of the first MAC CE 1000 and the second MAC CE 1010 marked “R” may be reserved for other purposes.

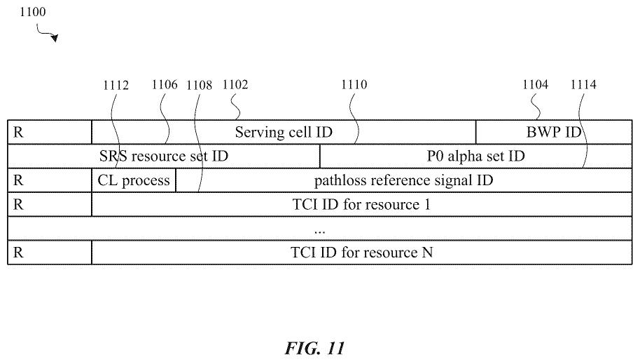

In some embodiments of the method 900, the set of one or more joint TCI states or UL TCI states may be received in a single MAC CE. The set of one or more joint TCI states or UL TCI states may be received per SRS resource in an SRS resource set, per SRS resource set, per group of SRSs across multiple CCs, or per group of SRS resource sets across multiple CCs. In at least some of these embodiments, a set of one or more power control parameters for transmitting the set of one or more SRSs may also be received in the MAC CE. The set of one or more power control parameters may be received per SRS resource set or per group of SRS resource sets across multiple CCs. In this manner common power control parameters may be applied to all of the SRS resources in an SRS resource set or all of the SRS resources in a group of SRS resource sets across multiple CCs (or to a single SRS resource when there is only one SRS resource in an SRS resource set). FIG. 11 shows an example structure of a single MAC CE 1100. The MAC CE 1100 may include one or more of a serving cell ID 1102, a BWP ID 1104, an SRS resource ID, an SRS resource set ID 1106, a TCI ID for an SRS resource 1108, a P0_alpha_set ID 1110, a CL process index 1112, and a pathloss reference signal ID 1114. By way of example, the MAC CE 1100 includes a TCI ID for each of SRS resources 1 through N.

In some embodiments of the method 900, the set of one or more joint TCI states or UL TCI states may be received in a MAC CE. The set of one or more joint TCI states or UL TCI states may be received per SRS resource in an SRS resource set, per SRS resource set, per group of SRSs across multiple CCs, or per group of SRS resource sets across multiple CCs. In at least some of these embodiments, the method 900 may include applying a set of one or more power control parameters for one SRS resource in an SRS resource set or group of SRS resource sets across multiple CCs to all of the SRS resources in the SRS resource set(s). In these embodiments, the UE need not receive the set of one or more power control parameters from the base station. However, the UE may be configured to select a set of one or more power control parameters associated with a particular SRS resource, for application to all of the SRS resources in the SRS resource set. The particular SRS resource may be, for example, an SRS resource with a lowest ID within the SRS resource set, or the first SRS resource in an SRS resource list within the SRS resource set. Alternatively, an SRS resource index can be indicated in RRC signaling or a MAC CE received by the UE, and the UE may select a set of one or more power control parameters associated with an SRS resource having the indicated SRS resource index, for application to all of the SRS resources in the SRS resource set.

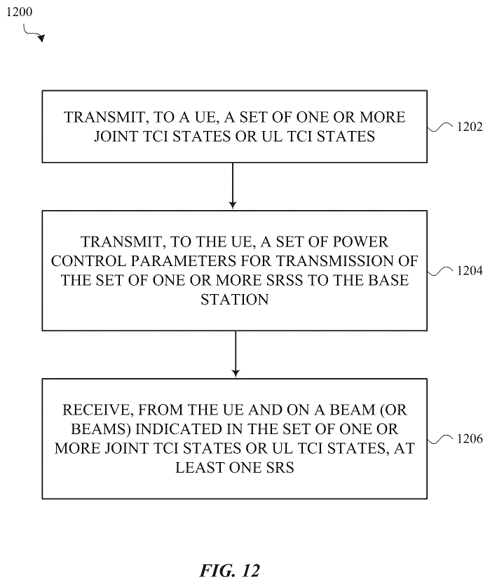

FIG. 12 shows an example method 1200 of a base station, which method 1200 may be used to indicate, to a UE, a beam for transmitting SRS and/or a set of power control parameters for transmitting SRS.

At block 1202, the method 1200 may include transmitting, to a UE, a set of one or more joint TCI states or UL TCI states. The set of one or more joint TCI states or UL TCI states may be transmitted to the UE in RRC signaling or at least one MAC CE. The set of joint TCI states or UL TCI states may indicate a set of one or more beams on which a set of one or more SRSs is to be transmitted to the base station by the UE.

At block 1204, the method 1200 may optionally include transmitting, to the UE, a set of power control parameters for transmission of the set of one or more SRSs to the base station. The set of power control parameters may be transmitted in RRC signaling or at least one MAC CE, and may be transmitted with or separately from the set of one or more joint TCI states or UL TCI states.

At block 1206, the method 1200 may include receiving, from the UE and on a beam (or beams) indicated in the set of one or more joint TCI states or UL TCI states, at least one SRS. The SRS(s) may be received, from the UE, in accord with the set of one or more power control parameters.

The method 1200 may be variously embodied, as described from the UE side with reference to FIGS. 9-11.

Embodiments contemplated herein include an apparatus having means to perform one or more elements of the method 500, 900, or 1200. In the context of method 500 or 900, the apparatus may be, for example, an apparatus of a UE (such as a wireless device 1402 that is a UE, as described herein). In the context of method 1200, the apparatus may be, for example, an apparatus of a base station (such as a network device 1420 that is a base station, as described herein).

Embodiments contemplated herein include one or more non-transitory computer-readable media storing instructions to cause an electronic device, upon execution of the instructions by one or more processors of the electronic device, to perform one or more elements of the method 500, 900, or 1200. In the context of method 500 or 900, the non-transitory computer-readable media may be, for example, a memory of a UE (such as a memory 1406 of a wireless device 1402 that is a UE, as described herein). In the context of method 1200, the non-transitory computer-readable media may be, for example, a memory of a base station (such as a memory 1424 of a network device 1420 that is a base station, as described herein).

Embodiments contemplated herein include an apparatus having logic, modules, or circuitry to perform one or more elements of the method 500, 900, or 1200. In the context of method 500 or 900, the apparatus may be, for example, an apparatus of a UE (such as a wireless device 1402 that is a UE, as described herein). In the context of method 1200, the apparatus may be, for example, an apparatus of a base station (such as a network device 1420 that is a base station, as described herein).

Embodiments contemplated herein include an apparatus having one or more processors and one or more computer-readable media, using or storing instructions that, when executed by the one or more processors, cause the one or more processors to perform one or more elements of the method 500, 900, or 1200. In the context of method 500 or 900, the apparatus may be, for example, an apparatus of a UE (such as a wireless device 1402 that is a UE, as described herein). In the context of the method 1200, the apparatus may be, for example, an apparatus of a base station (such as a network device 1420 that is a base station, as described herein).

Embodiments contemplated herein include a signal as described in or related to one or more elements of the method 500, 900, or 1200.

Embodiments contemplated herein include a computer program or computer program product having instructions, wherein execution of the program by a processor causes the processor to carry out one or more elements of the method 500, 900, or 1200. In the context of method 500 or 900, the processor may be a processor of a UE (such as a processor(s) 1404 of a wireless device 1402 that is a UE, as described herein), and the instructions may be, for example, located in the processor and/or on a memory of the UE (such as a memory 1406 of a wireless device 1402 that is a UE, as described herein). In the context of method 1200, the processor may be a processor of a base station (such as a processor(s) 1422 of a network device 1420 that is a base station, as described herein), and the instructions may be, for example, located in the processor and/or on a memory of the base station (such as a memory 1424 of a network device 1420 that is a base station, as described herein).

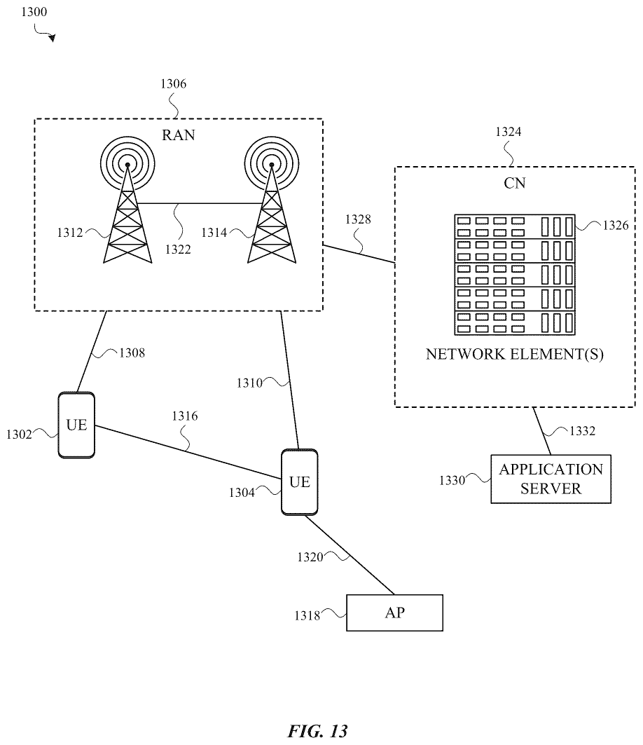

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations, such as base station 1312 and base station 1314, that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VOIP sessions, group communication sessions, etc.) for the UE 1302 and UE 1304 via the CN 1324. The application server 1330 may communicate with the CN 1324 through an IP communications interface 1332.

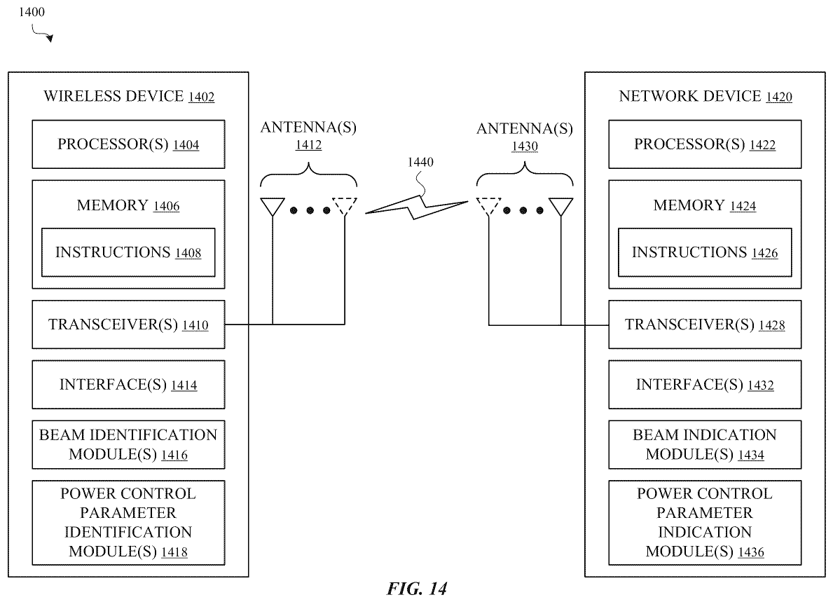

FIG. 14 illustrates a system 1400 for performing signaling 1438 between a wireless device 1402 and a network device 1420, according to embodiments disclosed herein. The system 1400 may be a portion of a wireless communications system as herein described. The wireless device 1402 may be, for example, a UE of a wireless communication system. The network device 1420 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter and/or receiver circuitry that use the antenna(s) 1412 of the wireless device 1402 to facilitate signaling (e.g., the signaling 1438) to and/or from the wireless device 1402 with other devices (e.g., the network device 1420) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include one or more beam identification modules 1416 and/or power control parameter identification modules 1418. The beam identification module(s) 1416 and power control parameter identification module(s) 1418 may be implemented via hardware, software, or combinations thereof. For example, the beam identification module(s) 1416 and power control parameter identification module(s) 1418 may be implemented as a processor, circuit, and/or instructions 1408 stored in the memory 1406 and executed by the processor(s) 1404. In some examples, the beam identification module(s) 1416 and power control parameter identification module(s) 1418 may be integrated within the processor(s) 1404 and/or the transceiver(s) 1410. For example, the beam identification module(s) 1416 and power control parameter identification module(s) 1418 may be implemented by a combination of software components (e.g., executed by a DSP or a general processor) and hardware components (e.g., logic gates and circuitry) within the processor(s) 1404 or the transceiver(s) 1410.

The beam identification module(s) 1416 may be used for various aspects of the present disclosure, for example, aspects of FIG. 1 through FIG. 12. The beam identification module(s) 1416 may be configured to, for example, receive, determine, and/or apply beam indications received from another device (e.g., the network device 1420).

The power control parameter identification module(s) 1418 may be used for various aspects of the present disclosure, for example, aspects of FIG. 1 through FIG. 12. The power control parameter identification module(s) 1418 may be configured to, for example, identify power control parameters for transmitting SRSs as described herein.

The network device 1420 may include one or more processor(s) 1422. The processor(s) 1422 may execute instructions such that various operations of the network device 1420 are performed, as described herein. The processor(s) 1404 may include one or more baseband processors implemented using, for example, a CPU, a DSP, an ASIC, a controller, an FPGA device, another hardware device, a firmware device, or any combination thereof configured to perform the operations described herein.

The network device 1420 may include a memory 1424. The memory 1424 may be a non-transitory computer-readable storage medium that stores instructions 1426 (which may include, for example, the instructions being executed by the processor(s) 1422). The instructions 1426 may also be referred to as program code or a computer program. The memory 1424 may also store data used by, and results computed by, the processor(s) 1422.

The network device 1420 may include one or more transceiver(s) 1428 that may include RF transmitter and/or receiver circuitry that use the antenna(s) 1430 of the network device 1420 to facilitate signaling (e.g., the signaling 1438) to and/or from the network device 1420 with other devices (e.g., the wireless device 1402) according to corresponding RATs.

The network device 1420 may include one or more antenna(s) 1430 (e.g., one, two, four, or more). In embodiments having multiple antenna(s) 1430, the network device 1420 may perform MIMO, digital beamforming, analog beamforming, beam steering, etc., as has been described.

The network device 1420 may include one or more interface(s) 1432. The interface(s) 1432 may be used to provide input to or output from the network device 1420. For example, a network device 1420 that is a base station may include interface(s) 1432 made up of transmitters, receivers, and other circuitry (e.g., other than the transceiver(s) 1428/antenna(s) 1430 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1420 may include one or more beam indication modules 1434 and/or one or more power control parameter indication module 1436. The beam indication module(s) 1434 and power control parameter indication module(s) 1436 may be implemented via hardware, software, or combinations thereof. For example, the beam indication module(s) 1434 and power control indication module(s) 1436 may be implemented as a processor, circuit, and/or instructions 1426 stored in the memory 1424 and executed by the processor(s) 1422. In some examples, the beam indication module(s) 1434 and power control parameter indication module(s) 1436 may be integrated within the processor(s) 1422 and/or the transceiver(s) 1428. For example, the beam indication module(s) 1434 and power control parameter indication module(s) 1436 may be implemented by a combination of software components (e.g., executed by a DSP or a general processor) and hardware components (e.g., logic gates and circuitry) within the processor(s) 1422 or the transceiver(s) 1428.

The beam indication module(s) 1434 may be used for various aspects of the present disclosure, for example, aspects of FIG. 1 through FIG. 12. The beam indication module(s) 1434 may be configured to, for example, transmit beam indications to another device (e.g., the wireless device 1402).

The power control parameter indication module(s) 1436 may be used for various aspects of the present disclosure, for example, aspects of FIG. 1 through FIG. 12. The power control parameter indication module(s) 1436 may be configured to for example, configure another device (e.g., the wireless device 1402) to use a particular set of power control parameters when transmitting an SRS.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a set of one or more transceivers; and
a processor configured to,
determine, at least partly from a transmission control indicator (TCI) state for multiple channels, that common physical downlink shared channels (PDSCHs) do not share a beam with dedicated PDSCHs;
determine a physical downlink control channel (PDCCH)/PDSCH scheduling offset is below a threshold;
select, at least partly based on the determination that common PDSCHs do not share a beam with dedicated PDSCHs and the determination the PDCCH/PDSCH scheduling offset is below the threshold, a beam for which to buffer PDSCH; and
buffer PDSCH received on the beam.

2. The UE of claim 1, wherein:
the beam is a default common PDSCH beam; and
the processor is further configured to select the default common PDSCH beam based at least partly on quasi co-location (QCL) information and a TCI state for a monitored control resource set (CORESET) in a latest slot.

3. The UE of claim 2, wherein:
the processor is further configured to determine there are multiple monitored CORESETs; and
the monitored CORESET in the latest slot is selected, from the multiple monitored CORESETs, as a CORESET with a lowest identifier (ID).

4. The UE of claim 3, wherein the multiple monitored CORESETs are common CORESETs in an active bandwidth part (BWP).

5. The UE of claim 2, wherein:
the processor is further configured to,
determine the UE is configured in a carrier aggregation mode;
identify a preliminary set of default common PDSCH beams for which to buffer PDSCH, the preliminary set of default common PDSCH beams including a preliminary default common PDSCH beam per component carrier (CC) in a band or a band group of the carrier aggregation mode; and
identify the beam for which to buffer PDSCH from within the preliminary set of default common PDSCH beams.

6. The UE of claim 2, wherein:
the processor is further configured to determine the UE is configured in a carrier aggregation mode; and
the latest slot corresponds to a component carrier (CC) having a minimum slot duration among a set of CCs in a band or a band group of the carrier aggregation mode.

7. The UE of claim 2, wherein:
the processor is further configured to determine the UE is configured in a carrier aggregation mode; and
the latest slot corresponds to a component carrier (CC) having a maximum slot duration among a set of CCs in a band or a band group of the carrier aggregation mode.

8. The UE of claim 1, wherein:
the beam for which to buffer PDSCH is a default dedicated PDSCH beam; and
the processor is further configured to select the default dedicated PDSCH beam based, at least in part, on the TCI state for multiple channels.

9. The UE of claim 1, wherein the beam for which to buffer PDSCH is a default common PDSCH beam or a default dedicated PDSCH beam.

10. The UE of claim 9, wherein:
the processor is further configured to receive, from a base station, radio resource control (RRC) signaling indicating whether to select the default common PDSCH beam or the default dedicated PDSCH beam as the beam for which to buffer PDSCH.

11. The UE of claim 9, wherein:
the processor is further configured to receive, from a base station, a medium access control (MAC) control element (CE) including an indication of whether to select the default common PDSCH beam or the default dedicated PDSCH beam as the beam for which to buffer PDSCH.

12. The UE of claim 1, wherein:
the processor is further configured to report a UE capability to a base station; and
the beam for which to buffer PDSCH is based at least partly on the UE capability.

13. The UE of claim 1, wherein the beam for which to buffer PDSCH alternates between a default common PDSCH beam and a default dedicated PDSCH beam in accord with a time domain multiplexing (TDM) framework.

14. The UE of claim 1, wherein:
the processor is configured to select the beam for which to buffer PDSCH as a beam for receiving an aperiodic CSI-RS.

15. A user equipment (UE), comprising:
a set of one or more transceivers; and
a processor configured to,
receive, via the set of one or more transceivers and in radio resource control (RRC) signaling or at least one medium access control (MAC) control element (CE), a set of one or more joint transmission control indicator (TCI) states or uplink (UL) TCI states, the set of one or more joint TCI states or UL TCI states indicating a set of one or more beams on which a set of one or more sounding reference signals (SRSs) is to be transmitted from the UE to a base station; and
transmit at least one SRS to the base station via the set of one or more transceivers, on an indicated beam in the set of one or more joint TCI states or UL TCI states, and in accord with a set of one or more power control parameters.

16. The UE of claim 15, wherein:
the set of one or more joint TCI states or UL TCI states is received in RRC signaling, per SRS resource in an SRS resource set; and
the processor is configured to,
receive, via the set of one or more transceivers and in RRC signaling, the set of one or more power control parameters for transmitting the set of one or more SRSs, the set of one or more power control parameters received for the SRS resource set.

17. The UE of claim 15, wherein:
the set of one or more joint TCI states or UL TCI states is received in RRC signaling, per SRS resource in an SRS resource set; and
the processor is configured to,
apply the set of one or more power control parameters for one SRS resource in the SRS resource set to all SRS resources in the SRS resource set.

18. The UE of claim 15, wherein:
the set of one or more joint TCI states or UL TCI states is received, per SRS resource, per SRS resource set, per group of SRSs across multiple component carriers (CCs), or per group of SRS resource sets across multiple CCs, in a first MAC CE; and
the processor is configured to,
receive, via the set of one or more transceivers and via a second MAC CE, the set of one or more power control parameters for transmitting the set of one or more SRSs, the set of one or more power control parameters received per SRS resource set or per group of SRS resource sets across multiple CCs.

19. The UE of claim 15, wherein:
the set of one or more joint TCI states or UL TCI states is received, per SRS resource, per SRS resource set, per group of SRSs across multiple component carriers (CCs), or per group of SRS resource sets across multiple CCs, in a MAC CE; and
the processor is configured to,
receive, in the MAC CE, the set of one or more power control parameters for transmitting the set of one or more SRSs, the set of one or more power control parameters received per SRS resource set or per group of SRS resource sets across multiple CCs.

20. The UE of claim 15, wherein:
the set of one or more joint TCI states or UL TCI states is received, per SRS resource, per SRS resource set, per group of SRSs across multiple component carriers (CCs), or per group of SRS resource sets across multiple CCs, in a MAC CE; and
the processor is configured to,
apply the set of one or more power control parameters for one SRS resource in the SRS resource set, the group of SRSs across multiple CCs, or the group of SRS resource sets across multiple CCs to the SRS resource, the SRS resource set, the group of SRSs across multiple CCs, or the group of SRS resource sets across multiple CCs.
